(19) United States
(12) Patent Application Publication
(10) Pub. No.: US 2010/0030841 A1
(43) Pub. Date: Feb. 4, 2010

(54) METHOD AND SYSTEM FOR SHARING INFORMATION BETWEEN USER GROUPS

(76) Inventors: Albert Busoms Pujols, Barcelona (ES); Alonso Joaquin Peralta Gimenez, Barcelona (ES); Albert Perez Esteve, Barcelona (ES)

Correspondence Address: LADAS & PARRY LLP, 26 WEST 61ST STREET, NEW YORK, NY, 10023, US

(21) Appl. No.: 12/182,879

(22) Filed: Jul. 30, 2008

(51) Int. Cl. G06F 15/16

(52) U.S. Cl. 709/202

(57) ABSTRACT

User groups (also known as communities) on the Internet, especially in social webs, can be structured through relationships of inheritance and association between them with the result that their content and services can be shared across these relationships in an automatic process. Thereto, the user groups comprise relationship configurations, defining if information of a certain type should be received from or sent to other user groups.

### BACKGROUND OF THE INVENTION

1. Technical field

The present invention relates to a method and a system for sharing of information generated by different types of services between user groups.

2. Description of related art

At the moment, users groups that can be found on the Internet are isolated groups. Relationships between the group users can be established without problems within their group. However, the user groups do not have any useful relationship with other user groups, whereto it would be useful or desirable to be related. This is because the user groups only inform their users of a relationship with another user group in a small corner at the bottom of their website and do not obtain more profit of the relationship, like sharing content or services. As a result, the knowledge generated in a user group cannot be easily shared with users of other communities or user groups with which they are related. Some examples of user groups or communities are social websites like Facebook, MySpace, LinkedIn and Xing as well as many weblogs as Blogger and other millions of communities throughout the Internet.

For this reason, it is an object of the invention to provide a method and system for easily sharing information between user groups.

### BRIEF SUMMARY OF THE INVENTION

Thereto, according to the invention a method according to independent claim 1 and a system according to independent claim 12 are provided. Favourable embodiments are defined in dependent claims 2-11 and 13.

According to an aspect of the invention, an architecture is provided to rebuild a net of user groups in order to have much more interaction between the groups and enabling that content of the group is easily shared with other groups and spread through the Internet. It also enables that user groups can perform action towards users outside the group or other groups through tools of representation of the group. For example, this also allows for communication between users and groups and also between groups. Finally, thanks to structuring the groups, casual users can navigate through them more efficiently because user groups are coupled to each other through relationships with different meanings.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows an example of a structured net of user groups.

FIG. 2 shows more complex examples of nets of user groups.

FIG. 3 shows an example of a relationship channel configuration.

FIG. 4 shows a flow chart of a process that may be performed when a user group generates some content.

FIG. 5 shows a flow chart of a process that may be performed when a user group receives content from a related group.

FIG. 6 shows an example of a conference set-up from a group and how it is shared it to users of all related groups.

FIG. 7 shows a flow chart of a process enabling a group to answer a question from another group or user with a representative system.

FIG. 8 shows a flow chart of a process that may be performed when a user navigates between groups through their relationships.

FIG. 9 shows an example of such user navigation.

Throughout the figures like reference numerals refer to like elements.

### DETAILED DESCRIPTION OF THE INVENTION

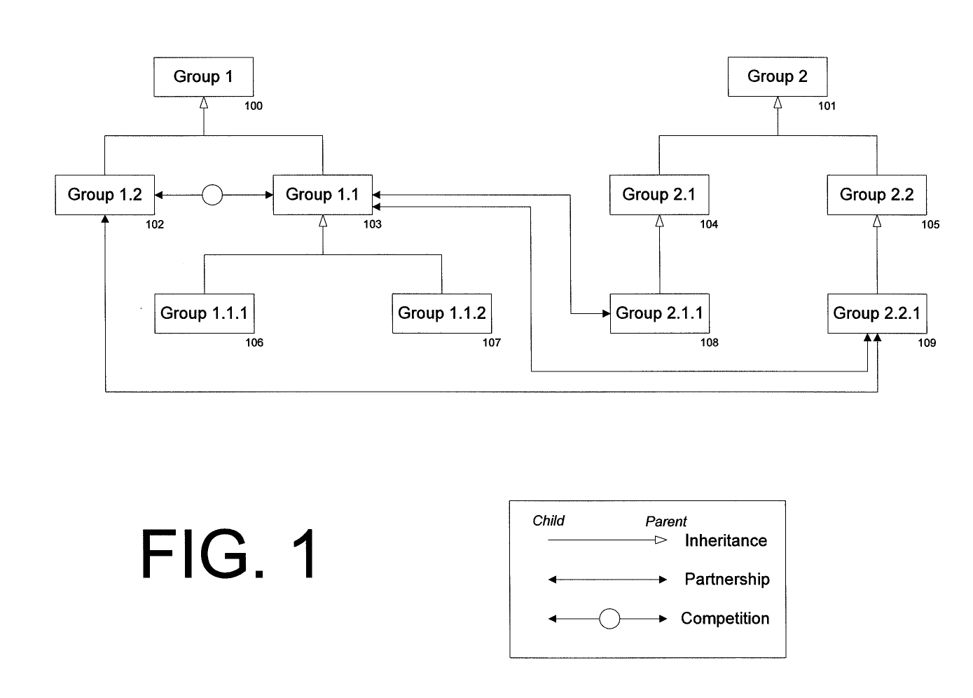

User groups can be related to each other by different relationships depending on function and reason of this relationship. There are two basic kinds or types of relationships depending on the position that each of the user groups occupies in the relationship. In the FIG. 1 each relationship is drawn with a line between the boxes that represent user groups.

The first one exists when one group is at a higher level than the other group because it includes the other group for some reason (e.g. because it is a subsidiary or it works on a more specific issue). This kind of relationship is called inheritance or parent-child relationship. This relationship allows to create nested groups or/and clustering of groups and subgroups. In order to easily understand which of the groups is included in the other one in the relationship, the group that includes the other group performs a role called “parent” and the other group, that is included in the first one, performs a role called “child”. In FIG. 1 the parent-child relationship is represented by a white one-side arrow.

The second kind of relationship exists when the groups are at the same level and it is called association relationship. The reason for this association can be diverse and subjective as long as the groups agree, for example, two companies may have a collaborative partnership because they already are working on the same topic or two opposing political forces can have an association in competition because they want their electorate to see how “wrong” their rivals are. In FIG. 1 the partner association is represented by a black two-side arrow and the competition association is represented by a black two-side arrow with a circle in the middle.

An example of a net of user groups with relationships is shown in FIG. 1. Describing it from the point of view of Group 1.1 (reference 103), it can be seen that it has an inheritance relationship with Group 1 (reference 100) wherein it is the child and Group 1 is the parent, two inheritance relationships with Group 1.1.1 (reference 106) and 1.1.2 (reference 107) where Group 1.1 (reference 103) is the parent and the other two are the children and finally a partnership association with Group 2.1.1 (reference 108) and Group 2.2.1 (reference 109) and a competition association with Group 1.2 (reference 102). The other groups are not directly related with Group 1.1 (reference 103), such as Group 2 (reference 101), which has inheritance relationships with Group 2.1 (reference 104) and Group 2.2 (reference 105), which at their turn have inheritance relationships with Group 2.1.1 (reference 108) and Group 2.2.1 (reference 109), respectively.

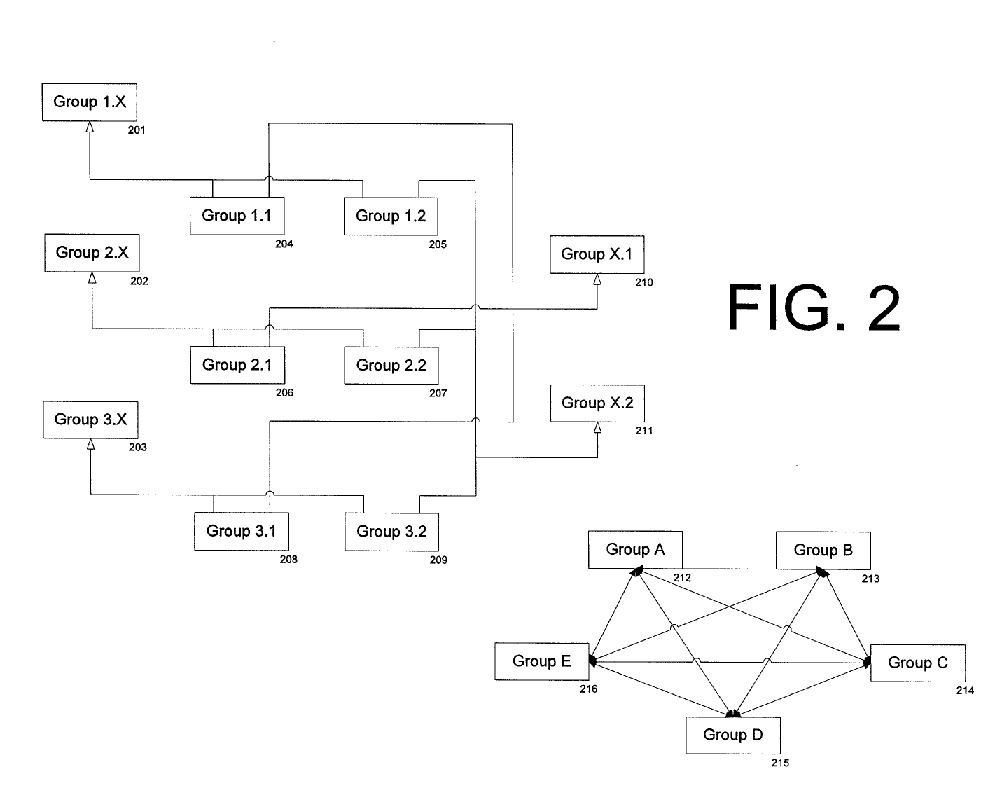

FIG. 2 shows two other examples of more complex nets of user groups. The first net (references from 201 to 211) is a double nested group. Each user group that is called Group Number.Number (as Group 1.1) (references 204-209) is included in two groups (this is the same as saying that it has two parent-child relationship): in a user group called Group Number.X (references 201-203) and in a user group called Group X.Number (references 210-211). The second net can be called a ‘Closed Star’ and has five user groups (references 212-216) where each of them only has associations with the other four. Each user group has different types of services with information that will be provided by its users, such as, but not limited to, photographs, videos, news, ads, polls, library, collaborative documents, conference, forums, user management (registration, login, logout, etc.), etc. For each of its relationships a user group has a configuration of the input and output for that relationship. This will be called a channel. A channel can be opened or closed for a certain service. For example, the input channel of a group coming from its parents may be open for all news that the parents generate and its output channel to its “children” may be closed for all news that the group generates. In this way, the service and the information that it generates will not be locked in a group and it can be spread among groups. Usually and as default, the user management service is input-opened and output-closed for the child and input-closed and output-open for the parent in the inheritance relationship.

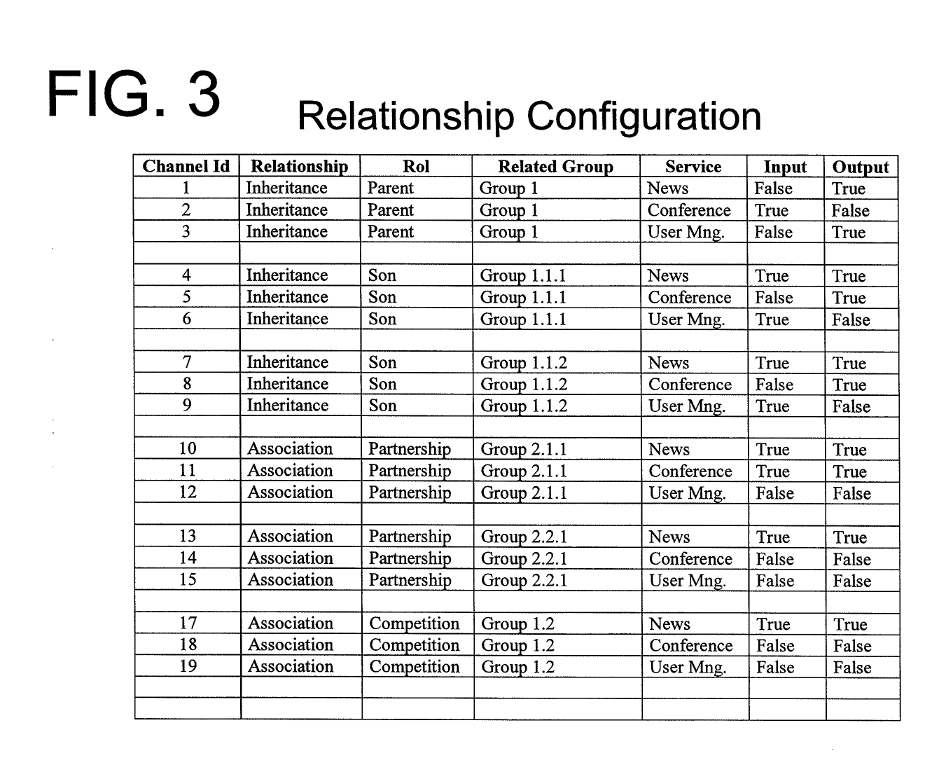

In FIG. 3 a relationship configuration of Group 1.1 (reference 103) of the FIG. 1 is shown assuming that it only has three types of services: user management, conference and news. For each of the channels of the group it is shown if the corresponding input and output are closed (“False”) or open (“True”).

Advantageously, any content that a group generates is given a natural number called Radius of Expansion (RE) that specifies how far this information generated by a service can reach, or in other words by how many user groups the information may be “passed on”. For each unit of the radius of expansion the content reaches one more user group. This limits the radius of influence that such information has in order to avoid the creation of too much noise.

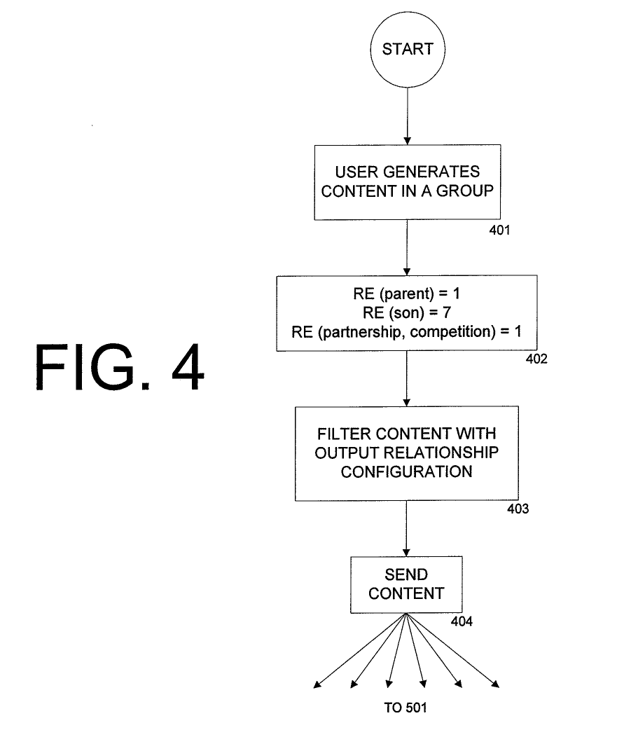

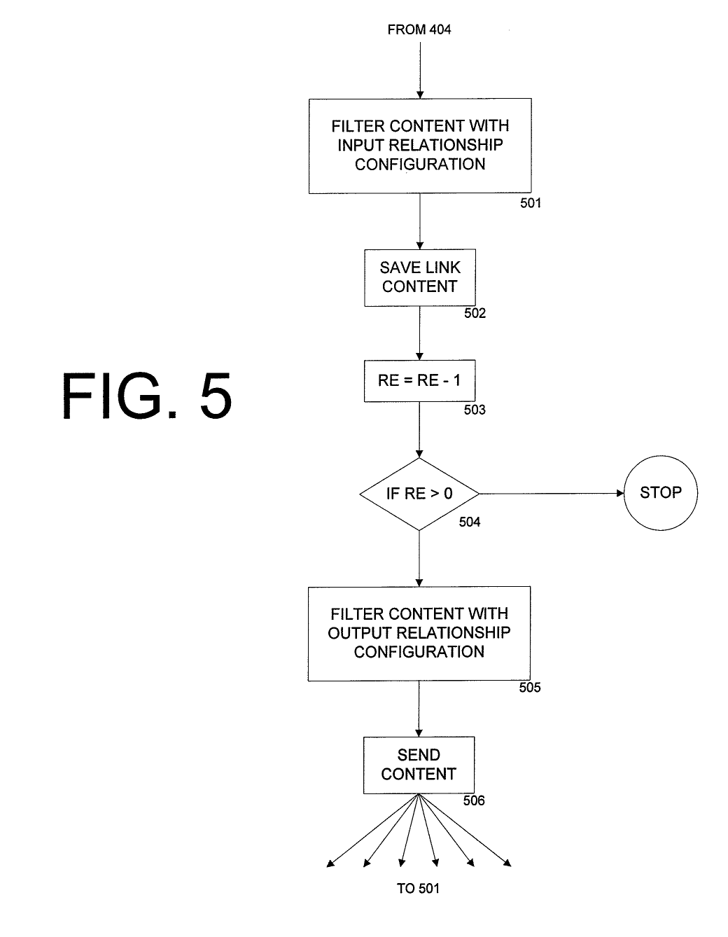

It is also possible to associate a different RE to the different channels of the relationship configuration. In that way, it is possible to spread the information of a service through the “children” of a group with a first RE, while the same information can be spread through its “parents” with a second, different RE. FIG. 4 shows the process that may be used when some user of a group creates some content or information related to a service in a user group and how it can be spread. First, the user generates some content for the user group in one of its service categories (step 401) and he assigns a Radius of Expansion for every relationship that the group has (step 402, this step is optional). Then the content passes through the filter that the group has for all output channels thereof (step 403) to determine where it must be sent. Thereto, the filter refers to the output relationship configuration. Finally, it is sent to all groups that have been determined in the previous step (step 404). In FIG. 5 it is shown what steps a group performs, when it receives some content on a certain input channel. First, it filters it by referring to the input relationship configuration to determine if the received content is accepted or rejected (step 501). If it is accepted, a link to the received content is saved (step 502). In that way the information is not repeated. Then, its Radius of Expansion is decreased by one unit (step 503) and if it is not 0 (checked in step 504), it is filtered by referring to the output relationship configuration (step 505) to obtain the users groups that it must be sent to and it is sent once again (step 506).

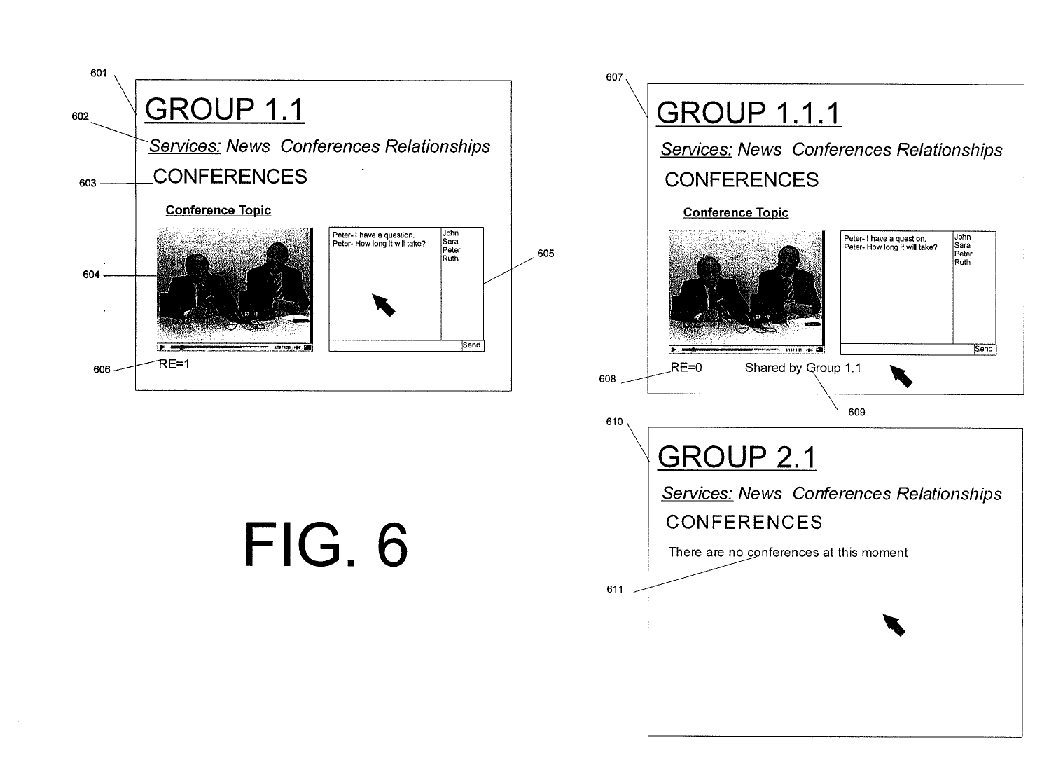

FIG. 6 shows a possible example of the production and sharing of a conference set-up by Group 1.1 (reference 103). As is shown in FIG. 3, the output-opened channels for the conference service are number 5, 8 and 11 (with Group 1.1.1, Group 1.1.2 and Group 2.1.1, respectively), so only the Group 1.1 and the other three will receive the conference. The page 601 of group 1.1 shows the Services links 602. The Conferences page 603 shows that a conference 604 is taking place by some user and other users can ask him questions through a chat 605. A value 606 of the RE of the conference specified by the user is shown. In this way the user defines how far he wants the information to be spread. At the same time, in the other groups that receive the conference a page 607 is shown with the relationship configuration and the same conference as is taking place in group 1.1. However, the value 608 of the RE shown on the page is different and the sentence 609 “Shared by Group 1.1” is written. The other groups that do not receive the conference, such as Group 2.1 cannot see it on their page 610 and a sentence 611 informs them that “There are no conferences at this moment”.

In this scenario a user group can run the same services as an individual user can. For this reason, it is the user group that spreads opinions and information and not any individual user who does it as representative of the group. To achieve this effect, there are different ways of reaching a group opinion on an issue, such as debating and voting of all users of the group or a selected group of users on contents that have been summarized by someone. It is also possible that somebody who represents the group speaks on behalf of it but anonymously.

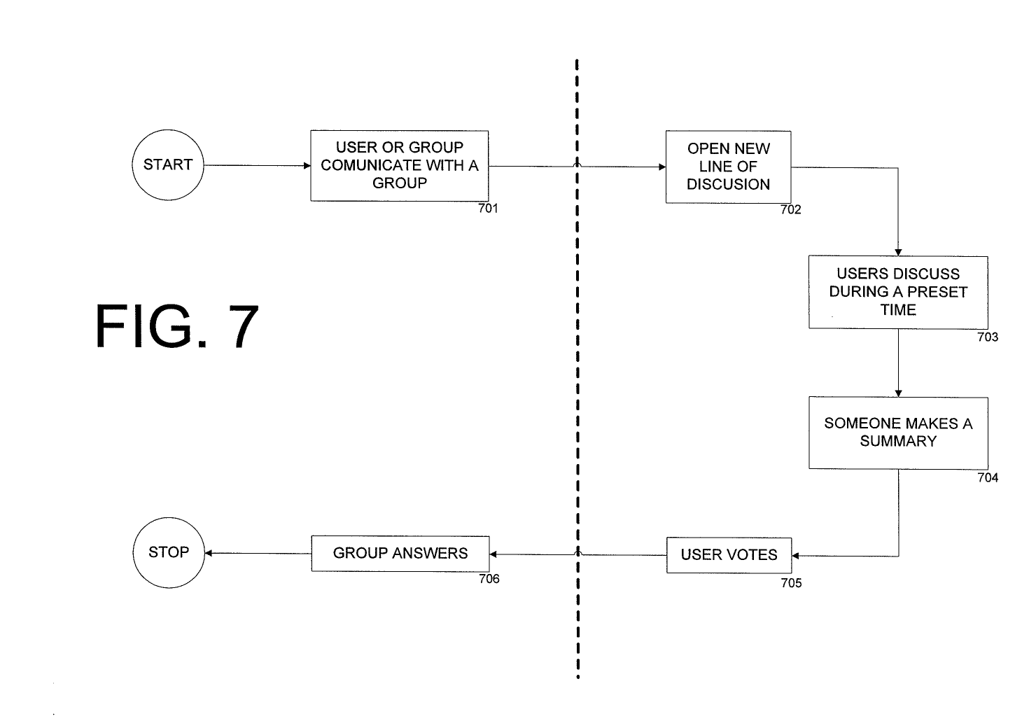

For example, as shown in FIG. 7, a user group or a user asks another user group its point of view on a topic (step 701). Then, the other user group automatically opens a line of discussion within the group (step 702) to listen to the point of views of its members during a preset period of time (step 703) and at the end of this time or when it is believed that a conclusion has been reached, someone makes a summary on behalf of the entire group (step 704) and it is given as the group opinion without revealing the name of users involved (step 706). Optionally, the answer can be put through a process of reaffirmation where the users vote in a positive or negative way (step 705). Another feature provided by this architecture is the enabling of improved navigation between different groups through their relationships thanks to the information regarding such relationships.

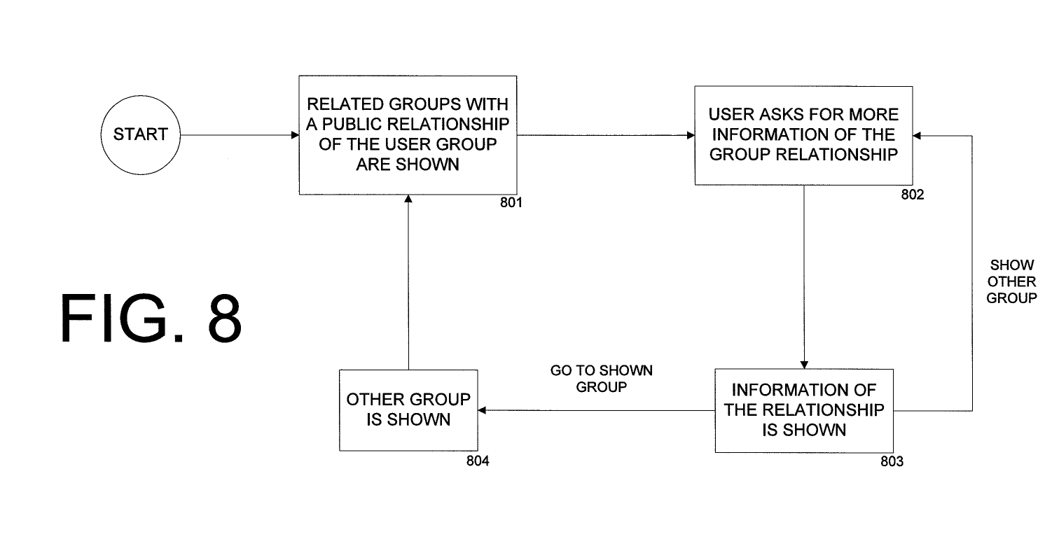

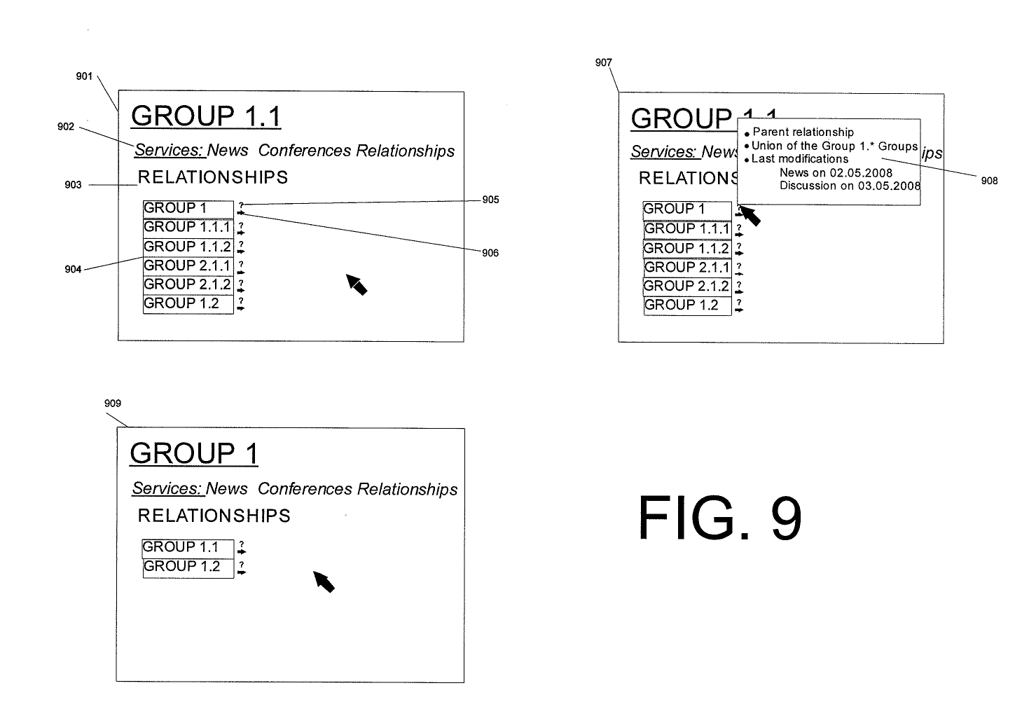

As is shown in FIG. 8, the process begins when in a user group a page is shown with their related user groups and a public relationship thereto (step 801). Then, the user can ask for information of one of these groups (step 802) and the system shows it (step 803). If the user wants to visit the group, he can do so by means of a link. The other group is then shown (step 804). FIG. 9 shows a simple example of this process. The first page 901 is the Group 1.1's page. It shows its services 902 and its Relationships space 903. In this space the groups 904 are shown that have a relationship with Group 1.1. Next to the related group there are two links: a question mark 905 that asks for more information and an arrow 906 that links to the related group. If a user clicks on the question mark as shown in page 907, some information of the Related Group is shown in pop-up window 908. If a user clicks on the arrow, a page 909 of the Related Group is shown.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Method for sharing information generated by different types of services between user groups, the user groups having relationships with other user groups and comprising relationship configurations defining input and output configurations of the relationships for the different types of services, wherein the different types of services are shared between the user groups according to the relationship configurations.

2. Method according to claim 1, wherein information generated in a user group is filtered according to the output configuration of the user group to determine to which other groups it should be sent, and wherein the information is sent to the determined other groups.

3. Method according to claim 2, wherein information is received by a user group from another user group and filtered according to the input configuration of the user group to determine if the received information should be accepted or rejected.

4. Method according to claim 2, wherein the information generated in a user group is given a radius of expansion number identifying how far the information should reach.

5. Method according to claim 4, wherein each user group receiving the information reduces the radius of expansion number.

6. Method according to claim 5, wherein a user group determines if the information should be resent to other user groups or not based on the radius expansion number.

7. Method according to claim 1, wherein the relationships between the user groups may be of the following types:
a parent-child relationship when one group is at a higher level than the other group and
an association relationship when the groups belong to the same level.

8. Method according to claim 1, wherein based on information received from another user group a new line of discussion is automatically created.

9. Method according to claim 8 wherein a group opinion obtained as a result of the discussion is communicated to the other user group without identifying group members involved.

10. Method according to claim 9 wherein the group opinion goes to a process of reaffirmation based on user voting.

11. Method according to claim 1, wherein the user obtains more information of a user group relationship.

12. Computer program comprising computer program code means adapted to perform the steps of claim 1, when said program is run on a computer.

13. System comprising a plurality of user groups comprising means for sharing different types of information between the user groups, the user groups having relationships with other user groups and comprising relationship configurations defining input and output configurations of the relationships for the different types of information, wherein the means for sharing are adapted for sharing the different types of information between the user groups according to the relationship configurations.
